(19) United States
(12) Patent Application Publication
(10) Pub. No.: US 2004/0007644 A1
(43) Pub. Date: Jan. 15, 2004

(54) Rotor craft

(75) Inventors: Arthur E. Phelps III, Williamsburg, VA (US); Elwood G. Norris, Poway, CA (US); Eugene F. Rock, New Port News, VA (US); Emitt Wallace, Carrollton, VA (US)

Correspondence Address: Attention: Clifton W. Thompson, THORPE, NORTH & WESTERN, L.L.P., P.O. Box 1219, Sandy, UT, 84091-1219, US

(73) Assignee: Airscooter Corporation

(21) Appl. No.: 10/423,831

(22) Filed: Apr. 25, 2003

Related U.S. Application Data
(60) Provisional application No. 60/375,660, filed on Apr. 25, 2002.

(51) Int. Cl. B64C 27/00

(52) U.S. Cl. 244/17.11

(57) ABSTRACT

An ultralight coaxial dual rotor helicopter having a substantially L shaped frame. Attached to the back of the frame is a vertical shaft engine, and a pair of yaw paddles for controlling yaw of the craft. The drive shaft connects to a belt drive at the top of the frame, which transmits the engine power to a transmission and coaxial drive gear for driving the rotors. Crank actuators are provided for tilting the rotor axis to control the pitch and roll of the craft. A pilot seat and ballast tank are attached to the front of the frame. The ballast tank may be filled with a volume of water to balance the craft for the weight of the pilot. The fuel tank is located behind the pilot seat on the centerline of the helicopter, such that as fuel is used and the w eight of fuel in the tank changes, the balance of the craft will not be affected. A simplified electronic control system controls all functions of the helicopter in response to pilot input.

### BACKGROUND

1. Field of the Invention

This invention relates to coaxial helicopter systems. More particularly, the present invention relates to an ultralight coaxial helicopter system.

2. Discussion of the Related Art

Coaxial helicopters were first developed, in the form of small devices used as toys and curiosities, centuries ago. The earliest attempts at designing a practical helicopter focused on coaxial rotors and dual counter-rotating arrangements. Later, what has come to be thought of as conventional helicopter designs were developed. These were single-rotor helicopters, and it was found that they needed a long tail boom having a tail rotor at the end rotating in a plane roughly perpendicular to the plane of rotation of the main rotor, in order to consistently apply a reaction moment to prevent the airframe of the helicopter from rotating uncontrollably in a direction opposite that of the rotor. This need for a tail rotor has given us the readily-recognized shape of conventional single-rotor helicopters.

As mentioned, earlier, it was theorized and proven that a helicopter with two counter-rotating rotors could be built such that the rotational force of one rotor counteracts the rotational reaction force of the other, leaving the helicopter body stable without the need for a perpendicularly acting tail rotor. The first controllable man-carrying helicopters were tandem-rotor designs. Tandem-rotor helicopters remain the most common dual-rotor helicopters.

Tandem-rotor helicopters such as the Chinook aircraft manufactured by Boeing Aircraft Corp. of Seattle, Wash. have been found to be particularly useful for heavy lifting operations where a large payload capacity is needed. Conventional tandem-rotor helicopters typically have an elongate body with a first rotor atop the front end, and a second rotor atop the rear end. The rotors can be elevationally offset so as to avoid contact with each other when rotating, or they may be separated by a sufficient distance to prevent contact.

Dual-rotor helicopters with coaxial rotors have also been developed. These helicopters include two counter-rotating rotors mounted on a single axis. While, as mentioned, coaxial helicopters have been known for many years, development of this type of aircraft has heretofore been limited because of complexities involved in arrangements for control of the rotor blades to give roll, pitch and yaw control. In conventional coaxial designs at least two swashplate assemblies are provided. A substantially conventional swash plate is provided below a lower rotor; and a swash plate assembly incorporating two counter-rotating swashplate portions is provided between the upper an lower rotors. Associated control links, push rods, etc. are needed, all so that cyclic and collective pitch control inputs to the upper rotor can be transferred past the counter-rotating lower rotor. As is known, using this arrangement it is a daunting task to provide a reliable aircraft without unduly burdensome maintenance requirements. The control arrangements are necessarily complex, and relatively high forces must be transferred by the swashplate assemblies and control links so they must be robust, and accordingly, heavy.

For these reasons, and others, in smaller helicopters conventional single-rotor designs, having a tail rotor for yaw control and for counteracting the tendency of the airframe to turn with respect to the rotor, predominate. Nevertheless, several successful coaxial designs have been developed, for example, by Nikolai Kamov and the Kamov design bureau of the former Soviet Union. The Kamov organization continues to produce coaxial helicopters in the Russian Federation. Other coaxial designs exist, for example a small coaxial pilotless craft developed by the Sikorsky division of United Technologies Corporation, of Hartford Conn. An example of a control system for this latter craft is disclosed in U.S. Pat. No. 5,058,824.

All aircraft, helicopters included, require control of attitude (including pitch, roll, and yaw), and linear motion (speed). The main rotor of a conventional single-rotor helicopter is typically configured to vary the pitch of the rotor blades cyclically and/or collectively to control pitch, roll, and lift, and therefore forward motion (or reverse, or side-to-side motion). Collective blade pitch control of the tail rotor controls yaw. The power output of the engine may also be varied, albeit within a fairly narrow operational power band, and this can affect lift and yaw.

In a conventional tandem-rotor and coaxial helicopters, these same attitude and lift controls are effected by cyclic and/or collective pitch variation of the blades of both rotors. Yaw control is by differential collective control inputs to the counter-rotating rotors, causing one to have more drag and the other less, thereby turning the aircraft about the yaw axis.

Coaxial helicopters potentially present many advantages over conventional single- and tandem-rotor helicopter designs. They can be more compact than a single-rotor design because of higher disk loading, and that fact that they have no need for a tail rotor for counter-acting the tendency of the airframe to turn around the rotor axis. Coaxial designs are more compact than a tandem design because there is no need to separate the rotors except for vertical rotor clearance. Because of said higher disk loading, coaxial designs can provide a given desired lifting force using a smaller diameter rotor set than comparable single-rotor helicopters. They require a smaller airframe than a comparable tandem-rotor helicopter. Moreover, because the rotors of a coaxial helicopter are disposed one on top of the other, and are counter-rotating, power efficiency losses due to vortex air movement adjacent the upper rotor can be at least partially recovered in increased effective airspeed and lift in the lower rotor. In other words, the upper rotor gives the air a whack in one direction, and the lower rotor gives it a whack in the other, canceling out a good part of the “whack.” Also, elimination of the tail rotor frees up the engine power otherwise diverted there. This savings has been cited as up to about 30% of total engine power in some cases.

However as noted above, there is a trade-off for these advantages in that providing for the control of coaxial rotor helicopters presents additional complexities and weight and maintenance concerns. One approach to mitigating the disadvantages of a coaxial arrangement is to eliminate the need for swashplates and complex control linkages altogether. Rather than adjusting the pitch of the coaxial rotor blades, an alternative for controlling coaxial helicopters is to make the axis of rotation of the coaxial rotor set tiltable with respect to the airframe, allowing pitch and roll control by effectively shifting the center of weight of the aircraft with respect to the thrust vector of the coaxial rotor set. Such a system is disclosed, for example, in U.S. Pat. No. 5,791,592 to Nolan, et al. (1998). In this simplified system, there is no need for cyclic blade pitch control, and there is no collective pitch control. Tilt of the coaxial rotor set, and increasing or decreasing the speed of the rotors, provides pitch, roll and lift control. Since, as mentioned, the disk loading in coaxial helicopters is higher and rotor diameter is smaller than conventional designs, adequate control of lift is possible without collective blade pitch control, though some lag in response is deemed inherent, and should be taken into account by a pilot operating a helicopter of this design.

Yaw control in the Nolan device is by means of two sets of airfoils which are tiltable. The airfoils are rotatable with respect to two sets of axes roughly parallel and normal, respectively, to the rotor thrust vector when the airfoils are vertically oriented. A larger airfoil set rotates about axes normal to the thrust vector, and impinges on the downwash from the rotor set. As the airfoils tilt to the right or left from a roughly vertical neutral orientation, this creates a reaction force vector tending to yaw the airframe right or left, depending on the angular direction of tilt of the larger set of airfoils. The second set of airfoils, which are smaller, and depend rudder-like from a rear edge of the larger airfoils, appear to function in a manner similar to a tail rudder in a conventional aircraft, and therefore appear to be more effective in yaw control when the device has developed significant forward speed, but appear to be is less operative in yaw control when the helicopter is hovering at a stationary point, or otherwise has very low forward speed.

With this background, it has been recognized by the inventors that for all the potential advantages of coaxial designs, heretofore there has not been developed a coaxial rotor helicopter in the ultralight class (as defined by FAA regulations) which provides acceptable flight characteristics at low cost. Known ultralight helicopters are of single-rotor design. Such known ultralight helicopters essentially mimic full-size conventional helicopter propulsion and control systems, and tend to be expensive.

### SUMMARY

It has been recognized that simplifications in design, and the weight and cost savings realized thereby, and commensurate potential advantages in performance for the same cost, argue for a simplified coaxial-rotor helicopter for an ultralight design. The present invention is directed to this end.

The present invention accordingly provides an ultralight coaxial helicopter comprising a substantially L-shaped frame with a tiltable coaxial rotor set disposed thereon and tiltably connected thereto. Also carried by the frame is at least one yaw paddle disposed in a downwash from the rotor set. The one or more yaw paddles are tiltable and otherwise configured so as to provide yaw control.

In a more detailed aspect, actuators, which are configured to be controllable by a helicopter operator also carried by the ]-shaped frame, are provided for tilting the rotor set axis relative to the frame to control the pitch and roll attitude of the craft by moving the center of gravity of the craft relative to the thrust vector of the rotor set. In further detail, a bottom portion of the “L” can extend forwardly to support an operator, and attached to a rear portion of the L-shaped frame is a vertical-shaft internal combustion engine for providing power to the rotor set through a damper, clutch, belt drive, and a CV joint at the tiltable connection of the rotor set to the frame. A transmission is mounted above the tiltable connection and is configured for providing counter-rotating shafts and comprises a pair of counter-rotating bevel gears operatively coupled to the respective shafts, and further comprises a plurality of beveled pinion gears disposed between the bevel gears.

In a further more detailed aspect, a pair of yaw paddles extend from the back of the airframe for controlling yaw of the craft as mentioned. These yaw paddles can be configured so as to provide a slight drag during forward flight to improve directability and controllability of the helicopter. In addition, two or more paddles can be provided. Providing a pair of paddles allows their cross sectional area to be reduced, reducing their susceptibility to yawing the aircraft in c ross-winds, while maintaining the same surface area to interact with rotor set downwash.

In another more detailed aspect, a pilot seat and a ballast tank are attached to the lower front of the L-frame. The ballast tank may be filled with a selected volume of water to balance the craft and account for differences in the weight of different individual pilots. A fuel tank is located behind the pilot seat on or adjacent a center of gravity of the helicopter, and substantially directly below the rotational axis of the rotors. This is done so that as fuel is used and the weight of fuel in the tank changes, the overall weight balance of the craft will not be noticeably affected.

In another more detailed aspect, a “fly-by-wire” control scheme can be incorporated, in that an electronic control system controls all functions of the helicopter in response to pilot input. Pilot input is through a control panel, control stick, etc, and which can further comprise a handlebar-like yoke, and a throttle lever. The throttle lever can be a separate control or incorporated in the yoke, for example by replacing it with a rotatable handgrip as is commonly used in motorcycle throttles. The handlebar-like yoke can be turned like a scooter handlebar for yaw input, pushed forwardly and rearwardly for pitch input, and tipped side-to-side for a roll input.

In another more detailed aspect, the control system can be configured to keep the pilot aware of altitude and to keep the forward speed of the aircraft below, a threshold value, so that the aircraft stays low to the ground and relatively slow in relative speed to mitigate harm to the operator from a crash. Furthermore, an emergency power system can be provided to provide temporary power to the rotors for landing in the event of sudden loss of engine power. This system can be powered by stored compressed air, or by another gas generated rapidly from a chemical gas generator triggered by a power failure. Further, additional safety provisions can include providing pontoons with blow-out plugs to mitigate a hard landing in a crash, providing a ground echo location capability and one or more explosive charges to slow the helicopter just prior to impact to mitigate a crash, and to program the control system to automatically take control of the aircraft in an emergency to provide for a relatively soft upright landing. The helicopter may be configured for carrying one or taco persons.

Other features and advantages of the present invention will be apparent to those skilled in the art with reference to the following detailed description, taken in combination with the accompanying drawings, which illustrate, by way of example, such features and advantages.

### BRIEF DESCRIPTION OF THE DRAWINGS

FIG. 1 is a left rear perspective pictorial view of an exemplary ultralight coaxial helicopter in accordance with the invention, some structure being deleted for clarity;

FIG. 2 is a left front perspective pictorial view of the helicopter of FIG. 1.

FIG. 3 is a front elevation view of the helicopter of FIG. 1, some structure not being shown for sake of clarity;

FIG. 4 is a left side elevation view of the helicopter of FIG. 3;

FIG. 5 is a top view of the helicopter of FIG. 4;

FIG. 6 is left side elevational view, partially in phantom to revel underlying structure, and some structure shown being shown partially in cross-section, and some structure not being shown so as to illustrate the principal elements of the helicopter and their relationship to the L-frame of the helicopter of FIG. 1;

FIG. 7 is a left side elevation view illustrating the L-frame and the rotor drive system components attached thereto of FIG. 6, certain elements being shown in a simplified or outline manner, and some elements being omitted altogether, for clarity of the figure;

FIG. 8 is more detailed close-up, partially cross-sectional view, of the belt drive, transmission and certain rotor drive portions of the L-frame and rotor dive system illustrated in FIG. 7;

FIG. 8a is a top view of the rotor control actuator system;

FIG. 8b is a perspective schematic illustration of the control system shown in FIG. 8a;

FIG. 9 is a cross-sectional view of the centrifugal clutch and sprag unit associated with the engine and drive shaft;

FIG. 9A is a cross-sectional view taken along line A-A in FIG. 9 of the centrifugal clutch and sprag unit shown in FIG. 9;

FIG. 9B is a cross-sectional view taken along line B-B in FIG. 9 of the centrifugal clutch of the centrifugal clutch and sprag unit shown in FIG. 9;

FIG. 9C is a cross-sectional view taken along line C-C in FIG. 9 of a sprag portion of the centrifugal clutch and sprag unit shown in FIG. 9;

FIG. 9D is a cross-sectional view taken along line D-D in FIG. 9 of the centrifugal clutch and sprag unit shown in FIG. 9;

FIG. 9E is a cross-sectional view taken along line E-E in FIG. 9 of a portion of a damping coupler above the centrifugal clutch and sprag unit shown in FIG. 9; and

FIG. 10 is a more detailed cross-sectional view of a transmission and rotor drive system;

Like reference numbers refer to like elements throughout the drawings showing the various exemplary embodiments.

It is an advantage of the present invention to provide a coaxial helicopter having pitch and roll controlled by tilting the coaxial rotor set. It is another advantage of this invention to provide an ultralight coaxial helicopter, which may carry one or two persons.

It is still another advantage of this invention to provide a coaxial helicopter having yaw paddles for controlling yaw by redirecting the rotor wash from the dual rotors. It is yet another advantage of this invention to provide a coaxial helicopter having a precise fly-by wire electronic control system.

### DETAILED DESCRIPTION

Reference will now be made to the drawings in which the various elements of the illustrated example(s) of embodiments of the present invention will be discussed so as to enable one skilled in the art to make and use the invention. It is to be understood that the following description is only exemplary of the principles of the present invention, and should not be viewed as limiting of the scope of any claims that may eventually be filed with respect to the invention.

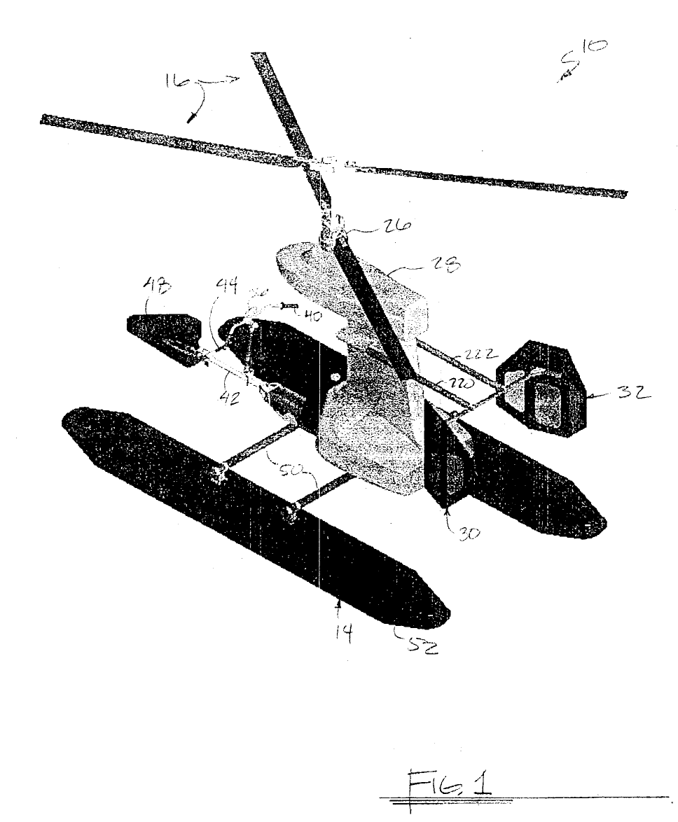

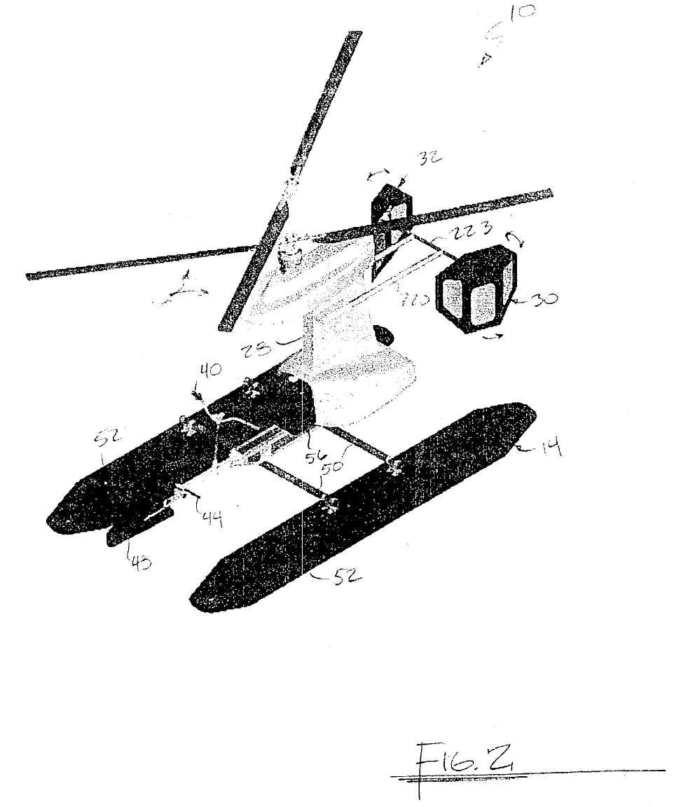

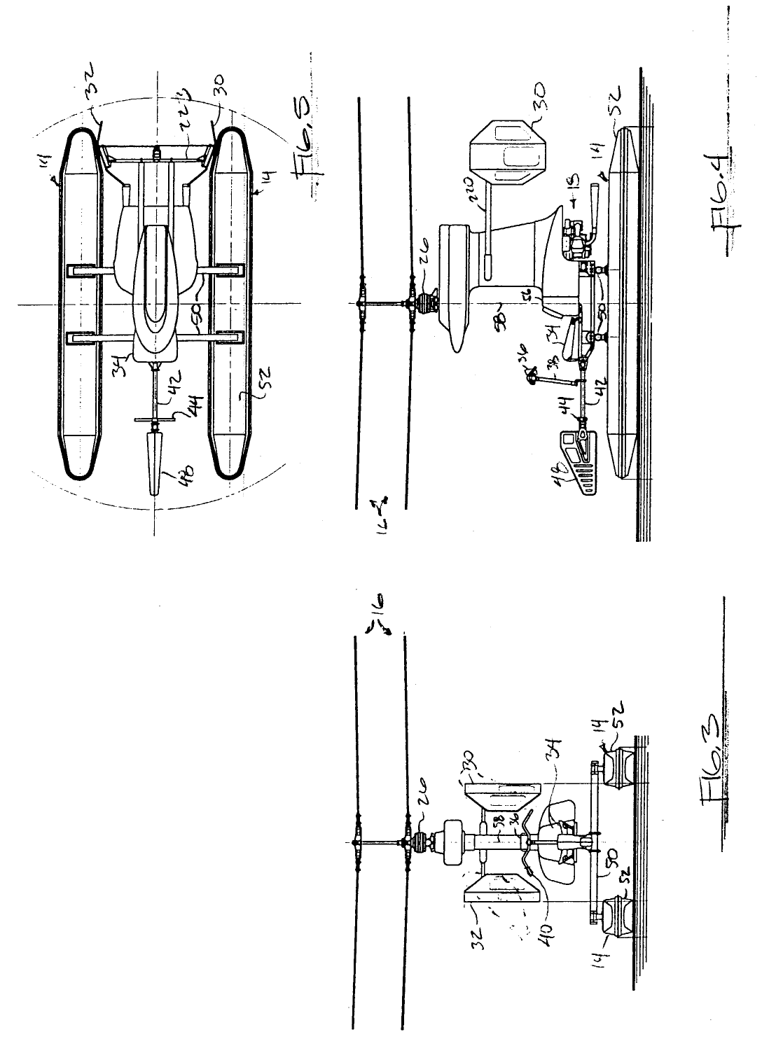

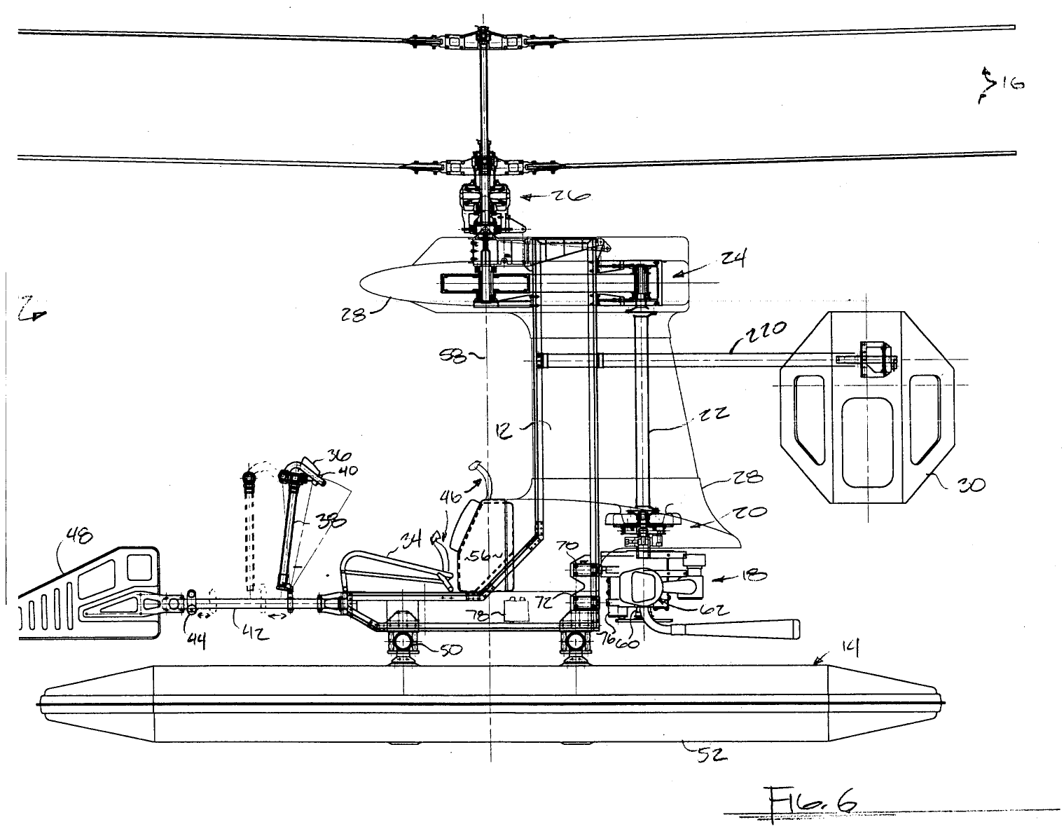

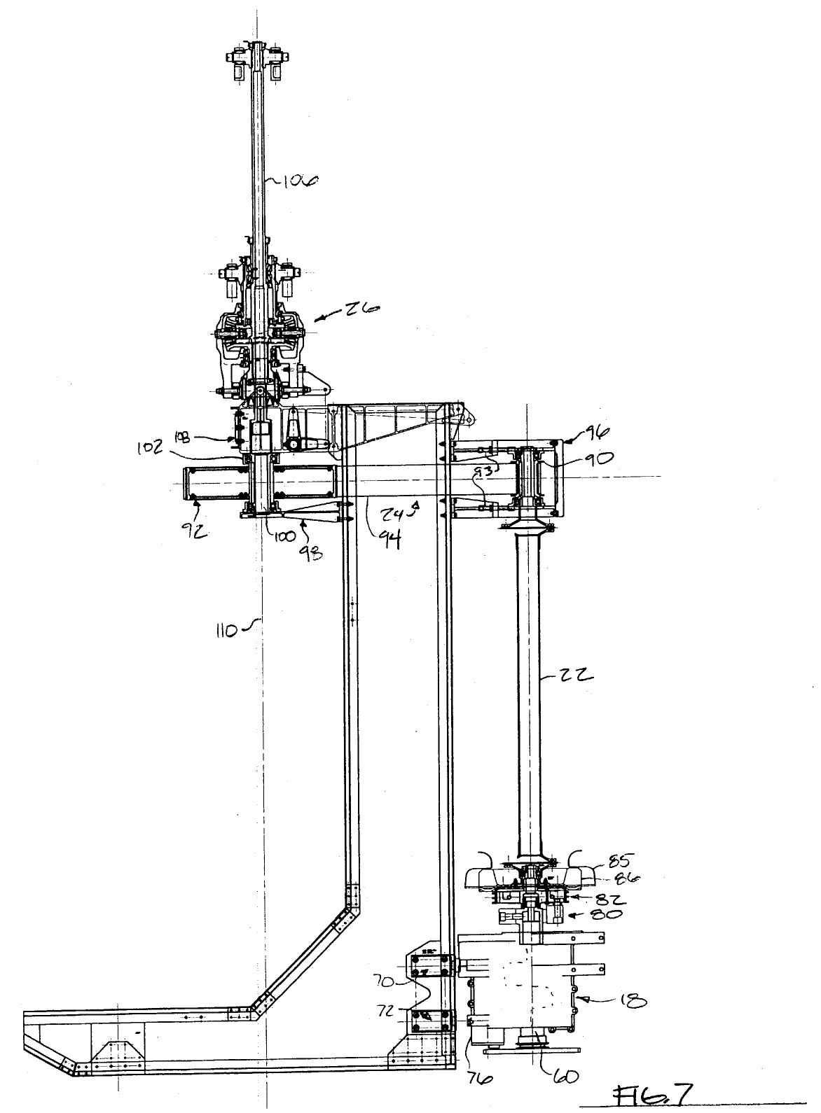

With reference to FIGS. 1 through 6 of the drawings, the invention is embodied in an ultralight helicopter 10 having a generally L shaped airframe 12 supported by pontoon landing skids 14 while on the ground, and a coaxial rotor set 16 when airborne. A gasoline engine 18 powers the coaxial rotors through a centrifugal and sprag clutch unit 20, drive shaft 22, belt drive transmission 24, and rotor coaxial drive transmission gear box 26. The engine, clutch, drive shaft, and belt drive transmission are preferably enclosed, either partly or entirely, within a sleek aerodynamic cowling or body 28 which improves the aerodynamics of the helicopter, and also improves its aesthetic appearance. Located rearwardly of the cowling and below the coaxial rotors are a pair of yaw paddles 30 and 32 which allow yaw control of the helicopter by redirecting rotor downwash to one side or the other, as described in more detail below. The yaw paddles also provide a slight drag force during forward flight, which enhances controllability of the craft.

An operator seat 34 and flight controls (including control panel 36, control stick 38, and throttle lever 40) are located on a forward boom 42 extending forwardly from the frame 12, below the coaxial rotor set 16, along with a pair of footrests 44 for the operator. A seatbelt system 46, preferably a four or five-point belt system, is provided for the operator's safety and security. The engine 18 and drive shaft 22 are disposed on the rear of the frame behind the operator seat, and a ballast tank 48 is provided on the extreme forward end of the boom 42, for allowing water or other fluid to be added or removed to balance the craft, depending on the weight of the operator. The landing gear 14 are attached to the frame by cross members 50. The landing skids depicted in the FIGs. comprise air-inflated pontoons 52, preferably formed of lightweight, durable polymer material. However, it will be apparent that other landing gear types may be provided instead of pontoons, such as wheels, skids, or other devices.

A fuel tank 56 is attached to the frame 12 behind the operator seat 34, directly below the centerline 58 of the rotors 16. This placement provides the advantage that as fuel is used and and the weight of fuel in the tank changes, the balance of the craft will not be affected because the weight of the tank is directly below the centerline of the upward force vector provided by the rotors. While the helicopter 10 depicted in FIGS. 1-6 is configured for a single operator/passenger, an ultralight helicopter embodying the features of the present invention may also be configured to accommodate 2 passengers. While including all of the same general features of the single seat embodiment, the two seat embodiment (not shown) includes a second operator/passenger seat and a slight rearrangement of mechanical elements to account for differences in weight and balance.

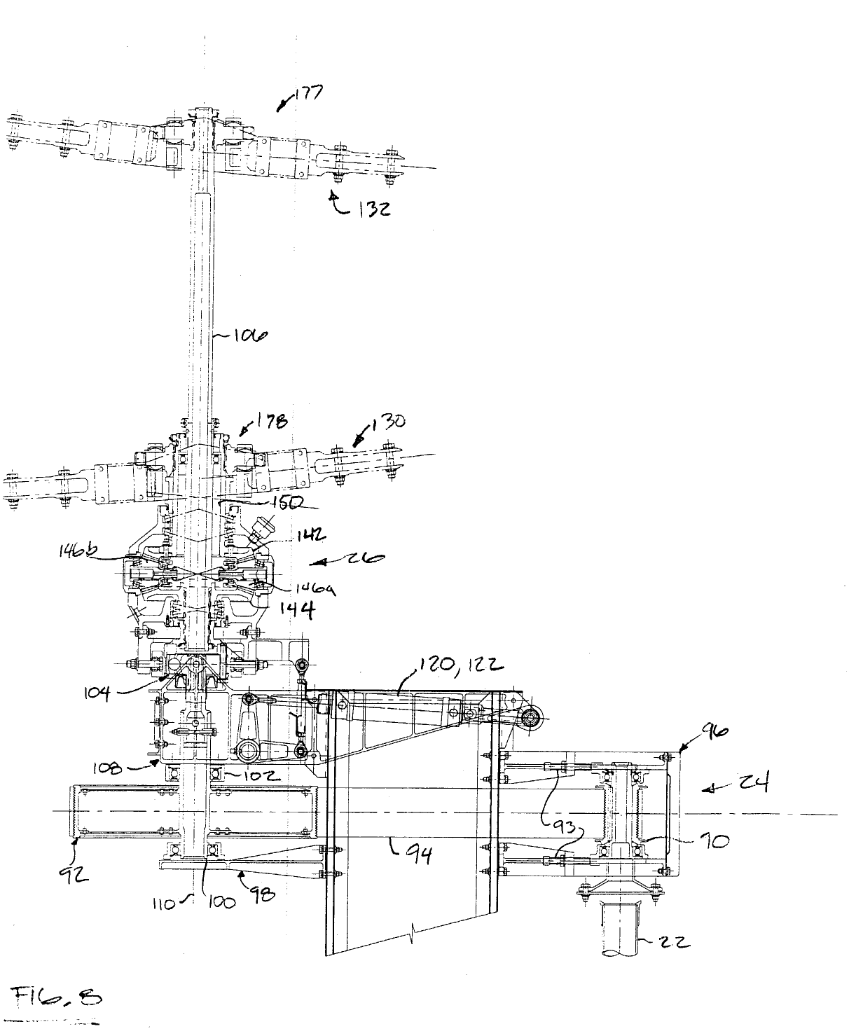

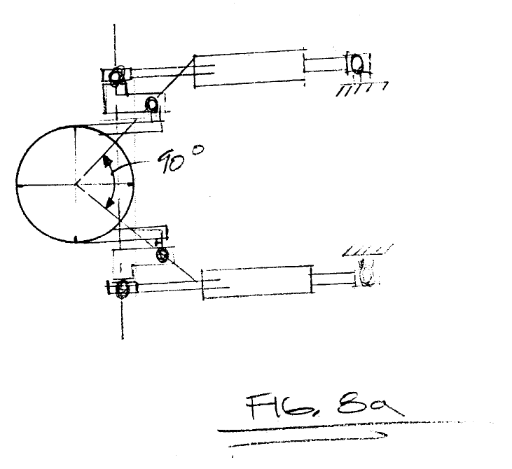

Viewing particularly FIGS. 6 and 7, the engine 18 is a vertically oriented piston engine, with a generally vertical crank shaft 60, which transmits power to the belt drive transmission 24 disposed at the top of the frame 12, above the pilot seat 34. The engine is preferably a two-cylinder, four-stroke, air-cooled aluminum engine similar to engines used in other ultralights, motorcycles, ATV's, and other small vehicles, though modified for its rotated (vertical) orientation. A suitable engine for the single passenger helicopter embodiment of FIG. 1 is manufactured by Pegasus Aviation (NZ) Ltd. of Bromley, Christchurch, New Zealand. Other engines may also be used, including other internal combustion engines, high power electric motors, turbine engines, etc. As will be appreciated another engine with suitable size, weight, and performance characteristics may be employed, whether now known or later developed. It will also be apparent that a more powerful engine will be required for a two person embodiment.

As used in the present invention, the preferred engine is rotated 90 degrees from what would be considered a normal engine operating orientation, such that the crank shaft 60 is vertical, and the cylinders 62 are substantially horizontal. This requires that the lubricating oil circulation system be modified for the rotated orientation. Internal combustion engine lubrication systems normally rely on gravity to return oil to an oil pan or sump, from which it is pumped for recirculation through the engine. This is a wet sump configuration. The engine of the present helicopter is modified such that it uses a dry sump, so that lubricating oil may be properly distributed throughout the engine.

The engine 18 is mounted to the rear of the L frame 12 by mounts 70, 72. These mounts are preferably formed integrally with the L frame and include elastomeric elements; and they securely hold the engine to the frame, while dampening its vibrations.

Other components associated with the engine include a starter motor 76, battery 78, and alternator. The starter motor, can function as the alternator in one embodiment, with appropriate electronics and switching. These arrangements are conventional and such components are relatively lightweight and compatible with the engine 18 used. Accordingly, the user may start the engine by activating controls on the control panel 36, which cause the starter motor to engage and start the engine.

It is recognized that helicopter rotor systems generally require a significant startup time while power is applied to overcome their inertia and drag resistance in order to reach operating speed. With reference to FIGS. 6, 7, and 9A-E, it will be appreciated that to allow unencumbered start-up of the engine 18 and gradual engagement of the engine with the rotor set 16, the crank shaft 60 of the engine is connected to the drive shaft 22 by a vibrational damper 80 and a centrifugal clutch 82. The damper reduces stress on the helicopter 10 and the engine 18 and its bearings by allowing for vibration and slight translation of the crank shaft 60, and the damper and clutch arrangement also allows for smoother transition in sudden variations in rotor speed due to drag, etc. from changes in environmental or control conditions.

An overrunning clutch, or sprag 84 is provided so that the rotor set 16 can continue to rotate if the engine 18 ceases to rotate, or dramatically reduces speed so as to otherwise put undue stress on the drive system. Provisions for air cooling of the clutch unit 20 are made, including a shroud 85 and fan 86.

Viewing FIGS. 6, 7 and 8, there is shown a cross-sectional view of the belt drive transmission 24. The engine drive shaft 22 extends generally vertically from the engine 18 to a drive pulley 90 associated with the belt drive transmission. The drive pulley transmits the rotation of the drive shaft to a transmission pulley 92 through belt 94. In addition to coupling the engine to the rotor drive transmission gearbox 26, the belt drive transmission may also be configured for adjusting the rotational speed to suit the rotor set 16 by variation of the relative sizes of the pulleys 90, 92. It will be apparent that the belt can be appropriately tensioned by tensioning bolts 93.

The drive pulley 90 and transmission pulley 92 are fixed to the frame through a drive pulley bracket 96, located rearwardly, and a transmission pulley bracket 98, located forwardly. The bearings for the pulleys are attached to these brackets. A transmission drive shaft 100 extends upward from the transmission pulley 92 through the transmission drive shaft bearing 102 to a constant velocity (CV) joint 104, which connects shaft 100 to a rotor drive shaft 106. A gimble arrangement is provided here coaxially with the CV joint to tiltably connect the rotor drive transmission gearbox to a transmission mounting bracket 108 fixedly connected the top of the frame 12, and the transmission drive shaft bearing 102 is disposed therein. The transmission mounting bracket 108 extends generally in line with the long axis of the airframe, such that the transmission pulley 92 and transmission drive shaft bearing 102 are disposed above the operator seat 34. The drive pulley 90 and drive pulley bracket 96 are located behind the frame, directly above the engine 18.

It will be appreciated that during flight the entire lifting force of the rotor set 16 of the helicopter 10 will be transmitted through the transmission mounting bracket 108, which must therefore be very strong. The bracket bolted together and is formed of an alloy of aluminum or steel, and is machined to accommodate secure connections to the frame, and attached bearings, pulleys, fittings, etc.

The gimble arrangement mentioned, and the CV joint 104 allows the rotor drive shaft 106 to tilt forward and back, and side to side, within a conical range, allowing pitch and roll control of the helicopter through tilting the rotor axis 110. Rotor pitch and roll control actuators 120 and 122 control the tilting of the rotor axis in orthogonal directions, and are described in more detail below. Disposed above the joint 104 is the rotor transmission gear box 26 for converting the unidirectional rotation of the rotor drive shaft into counter-rotational driving force for the lower and upper rotors 130 and 132, respectively. The rotor gear box 256 includes a first bevel ring gear 142 and a second bevel ring gear 144, and plurality of pinion gears (146a and 146b are shown, but 4 pinion gears can be used).

The power in the first rotor drive shaft 106 divides into a second or outer drive shaft 150, and an inner and outer drive shafts are concentric with each other. The first, or lower rotor 130 is actuated by the outer drive shaft through the upper, bevel gear 142. The second, or upper rotor 132 is driven by the second, or inner, drive shaft through the second, or lower, bevel gear 144. Power is transmitted to the first and second bevel gears by the pinion gears 146, which rotate about, and are connected to the rotor gear box housing 154 via bearings 156. It will be apparent that the counter-rotational gear drive could be configured in other ways, such as a planetary gear arrangement (not shown), or other gear arrangement for causing one rotor to rotate counter to the other. The gear drive could also be configured to include a reducing gear set to chance the rotational speed of the rotors relative to the rotor drive shaft 100.

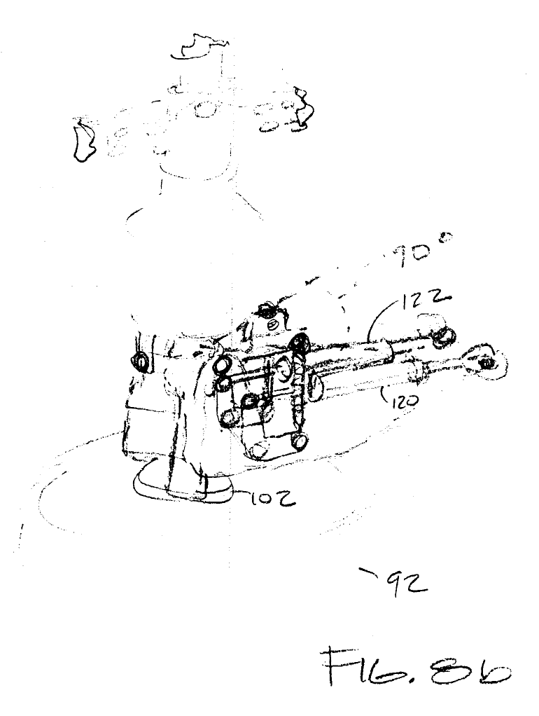

Viewing FIGS. 8, 8a, and 8b there is shown a rotor control actuator system. As noted above, the rotor control actuators 120 and 122 tilt the counter-rotational gear drive and rotor set with respect to the airframe in response to control inputs provided by the operator and the electronic control system, to provide pitch and roll control for the helicopter 10. The rotor control actuators 120 and 122 are preferably hydraulic actuators, but can be electrical servos which comprise an actuator body 160 and a linearly extendable or retractable actuator rod 162. The actuator bodies 160 are hingedly connected to the transmission bracket 108 at a top of the frame 12, and the actuator rods are pivotally connected to first arms 1658 of bell cranks 164 and 166, which are pivotally connected to the to the transmission mounting bracket 108. A second arm 170 of each bell crank is pivotally connected to the gear box housing 154 through a push rod 172.

As shown, the push rods 172 are attached to lever arms 174 which are mounted to extension arms 176 of the gear box housing 154. The vertical location of the lever arms aligns them with the pivot point of the universal joint 104, and the ball joints at the rear ends thereof are on axes oriented 90 degrees apart with respect to the rotor axis 110, so as to allow proper operation. When the actuators tilt the rotors, this shifts the center of gravity of the airframe (and everything supported thereby) relative to the rotor set. In this way, the center of gravity of the airframe, and therefore of the helicopter as a whole, is shifted with respect to the upward thrust generated by the rotor set. The helicopter will change attitude, depending on the direction of tilt of the rotors. Pitch and roll control is thus effected by w eight shifting, as opposed to conventional control by cyclic alteration of the pitch of the rotor blades.

As mentioned, the lever arms 174 are horizontally positioned at locations which are rotated 90° from each other, but are not aligned with the longitudinal or transverse axes of the helicopter frame. Rather, the lever arms are preferably rotated 45° from the longitudinal and transverse axes of the helicopter. Because of this configuration, both actuators operate in tandem to properly adjust the rotor axis for pitch and roll control. For example, to move the helicopter forward, both actuators must extend equally, causing the bell cranks to tilt the gear box housing 154 and rotor set forward, along the longitudinal axis of the helicopter. This tilts the rotor set forward, creating a forward component of force which causes the craft to move forward. To cause the craft to roll left or right, the rotor set must be tilted to the left or right, respectively. To do this, the actuators must move differentially, such as one actuator extending and the other retracting, or one extending to a lesser degree than the other. The cooperative operation of the actuators is caused by the controller based on operator input to the control stick. Using this control system, the rotor set can be caused to tilt forward, backward, side to side, or any combination thereof in a conical range.

It will be apparent that the spinning rotors will create a gyroscopic effect which will tend to resist being tilted. Because of this tendency, when the actuators push upon the housing 154, the initial reaction of the craft may be a combination of tilt of the rotors and tipping of the airframe, at least in absolute terms, with respect to the ground, for instance. Then, as gravity pulls the center of mass of the airframe back to a point vertically below the center of lift, the airframe will regain its intended horizontal alignment, and in so doing pull the rotors to the desired tipped orientation. For example, when the actuators move to tip the rotors to the right, the right side of the airframe will tend to tip upward, as the right side of the rotors tips downward, until the airframe corrects itself and the weight of the airframe pulls the right side of the rotors down to the intended position.

As can be appreciated, because they operate in tandem, the actuators need not be disposed at exactly 45° offset from the centerline of the helicopter, nor do they need to be offset 90° from each other. In theory, the actuators could be placed at any offset relative to the helicopter centerline, so long as their control linkage lengths are suitable to allow adequate deflection in each desired direction. As a practical matter, the inventors have found that the actuators can be configured for operation at an offset of anywhere from 25° to 65° relative to the centerline, though 45° is preferred. So long as the computer controller is programmed to cause proper differential motion of the actuators, the rotor axis can be properly controlled so that pitch and roll response is immediate and precise.

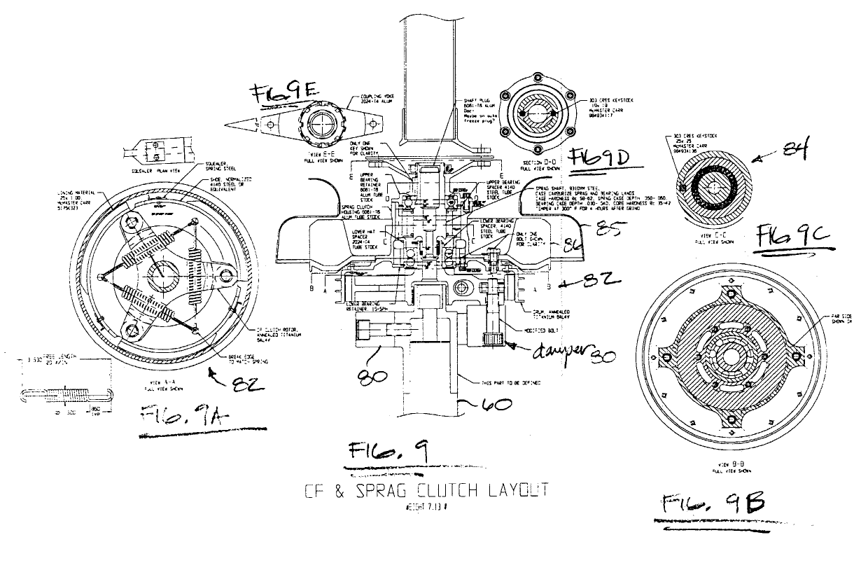

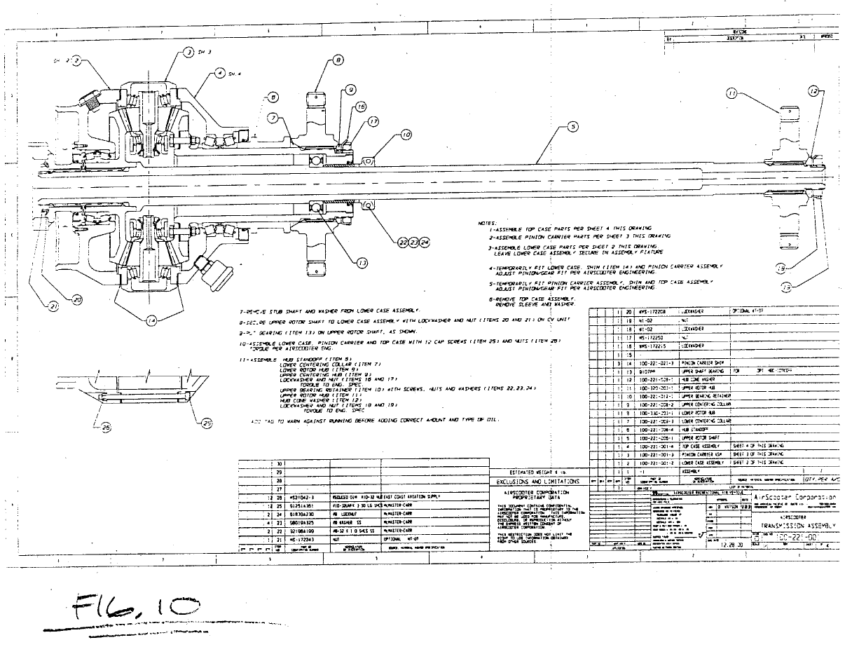

The rotor blades for use with the helicopter of the present invention are preferably fiber composite blades which are fixedly connected to the blade hubs 177, 178 of the upper and lower rotor sets. A rotor blade 180 configured for use with the invention is depicted in FIG. 9. Unlike conventional helicopters, by virtue of its tiltable rotor axis, the coaxial helicopter of the present invention does not require collective or cyclic pitch control of the rotor blades to control pitch and roll. This simplified control system allows the rotor blades and hubs to be simpler and more rugged in design, while also being lightweight. At the same time, the rotor blades are fixed in their orientation relative to the rotor axis, and do not have a neutral lift position. Consequently, the lift of the helicopter is controlled by the rotational speed of the rotors.

The first, or lower, set of rotor blades 130 are attached to the outer drive shaft 150 by blade cuffs 190, comprising clevis pieces 192 attached to a rotor hub 194 connected to the outer drive shaft through a teetering hinge pin disposed substantially orthogonally to the longitudinal axes of the lower rotor blades. The teetering hinge is located slightly above the rotor hub, and accordingly the lower rotor set is under-slung.

The outer drive shaft 150 is supported by outer bearings 196 and a sleeve 198 . A set of inner bearings 200 are disposed between the outer drive shaft and the inner drive shaft 152. Another bearing 202 is disposed between the inner drive shaft and the case at the lower end of the inner drive shaft adjacent the hub. These bearings support the various elements and allow rotation and counter rotation of the elements as described therein.

Details of connection of the second or upper set of rotors 132 will now be described in more detail. The rotors are inclined slightly upward, forming a coned rotor set, in contrast to the lower rotors 130 which are horizontal. The angle of coning is about 2.5 degrees upward.

It should be noted that the upper rotors are pitched less than the lower rotors to account for the fact that there is, in effect, an inflow from the upper rotor to the lower rotor and accordingly for the two rotors to be “balanced”, so as not to induce rotation of the airframe, the lower rotor must have more “bite.” The rotors are underslung, and are limited in teetering so as not to interfere. The pitch of both rotors is fixed but can be adjustable on the ground to allow for balancing.

With reference to FIGS. 1-6, yaw control in the illustrated embodiment is facilitated by yaw paddles 30 and 32, which are disposed rearwardly on the airframe, below the counter-rotating coaxial rotor set. The yaw paddles 30 and 32 are connected to the airframe by a pair of yaw paddle booms 220 and 222, which extend rearwardly from the cowling 28. The yaw paddles are configured to pivot on a transverse boom 223 supported by the yaw paddle booms, such that the yaw paddles may rotate with respect to downwardly flowing air from the rotor set (the rotor downwash), and thereby deflect air laterally to produce a sideways thrust vector which is offset from the center of mass of the helicopter (and from the axis of the rotor thrust vector), for rotating or yawing the airframe right or left about the rotor axis.

Rotation of the yaw paddles is controlled by a yaw paddle control actuator 224, which activates a yaw paddle hydraulic servo 226 attached to a transverse yaw paddle beam 228. The servo 226 has a crank 230 *which is connected by a yaw linkage 232, preferably a flexible cable, to a yaw control arm 234 located on the interior side of each yaw paddle. By virtue of this configuration, when the servo is actuated to deflect right or left, both yaw paddles simultaneously angle right or left, deflecting the rotor downwash accordingly. The yaw paddle control actuator 224 further comprises adjustability in the yaw control arm 234. Combined with adjustability in the crank 230, yaw control can be made more sensitive or less sensitive, and a “neutral” position can be adjusted to counteract any slight imbalance in the counter rotating coaxial rotor set, which could tend to yaw the airframe right or left.

As depicted in the drawings, the yaw paddles naturally have an airfoil shape, and in their “neutral” position are disposed at an angle to the forward flight direction. This configuration causes the yaw paddles to produce a dragging force on the helicopter in forward flight. This drag helps stabilize the helicopter during forward flight, making it easier to control, and keeping it pointing forward. This additional drag is not considered a significant hindrance to flight because the helicopter is designed to fly at relatively low speeds (e.g. about 30 mph). It will be apparent, however, that the yaw paddles could make the craft difficult to handle in windy conditions.

The yaw paddles are preferably formed of a fiber resin and foam composite which is rigid, yet lightweight.

The helicopter of the present invention employs an innovative fly-by-wire control system. All control functions—engine/rotor speed, tilt of the rotors, and rotation of the yaw paddles—are effectuated by servo motors actuated by an electronic controller 250. The electronic controller receives control input from the flight controls, including the control panel 36, control stick 38, and throttle lever 40, which are manipulated by the operator, and are forwardly disposed on the airframe within convenient reach of an operator seated in the operator seat. Using a simplified control methodology, the electronic fly-by-wire system is also relatively simple, and the flight controls are configured to be very intuitive. The control panel 36 preferably includes a conventional key-operated ignition switch 252, and a variety of indicators and gauges 254, as desired, for monitoring the functions of the craft. These may include engine rpm and fuel level gauges, electrical and safety system indicator lamps, and even attitude, altitude, and heading indicators, etc.

The throttle lever 40 is a simple lever which is hingedly connected to the airframe via a motion sensor 256 just below and to the rear of the operator seat. When the operator pulls the free end of the lever up, the motion sensor detects the amount of rotation, and sends a corresponding signal to the controller, which opens the throttle proportionally, increasing the power output of the engine. When the operator lets the end of the throttle lever down, the throttle is proportionally closed in the same manner, reducing engine output.

The control stick 38 may take many forms. One form which the inventors prefer is a handlebar configuration, as shown in the FIGS. The handlebar-type control stick includes an upright post 260, and a transverse handlebar 262 mounted to its top. The bottom end of the upright post is connected to the forward boom by a hinged connector 264 which allows motion of the upright support in two or three degrees of freedom: the upright post can pivot forward and backward, and side-to-side, and may also rotate about its longitudinal axis. The forward/backward motion of the post is detected by a pitch sensor 266, and the side-to-side motion of the post is detected by a roll sensor 268, both of which are disposed in the connector 264 at the bottom of the post. A yaw sensor 270 disposed in the hub 272 of the handlebar detects rotation of the handlebar. The handlebar may alternatively be fixedly connected to the upright post, with the rotation sensor 270 disposed at the base of the post. Consequently, rotation of the handlebar causes axial rotation of the upright post, which actuates the yaw paddles to control yaw of the helicopter.

The sensors 266, 268, and 270 convert the relative motion of the stick and handlebar into electrical impulses which are received by the electronic controller. Pivoting of the control stick, forward or backward, or side-to-side, controls the rotor tilt actuators, which control the pitch and roll of the helicopter. Rotation of the handlebar controls the motion of the yaw paddles, causing the craft to yaw left or right. The combination of pitch, roll, and yaw control using the control stick, and lift control through the throttle control, provides complete operational control of the helicopter through a very simple and intuitive scheme which is easy for operators to learn, even those without any prior flying experience.

As an alternative to the handlebar-type control stick, the control stick 38 may be a joystick-type controller. The joystick comprises a generally vertical stick 272 which is moveable forward, backward, and side to side in a conical range for control of pitch and roll. For yaw control, the stick may be axially rotatable or have a rotatable handle grip 274, which when twisted causes the yaw paddles to rotate one direction or the other to control horizontal rotation of the helicopter. The joystick may be relatively large and centrally mounted on the forward boom as shown, or may be a relatively small stick mounted to an armrest 276 attached to the side of the operator seat.

The joystick may also include a throttle control button 278, to replace the throttle control lever 40. This button is preferably located atop the joystick, and is operable by the user's thumb, though other configurations may be employed. When the button is pressed forward by the operator, the controller opens the engine throttle until the user discontinues pressure on the button (or a full throttle position is reached), and holds the throttle at that level. Conversely, when the throttle button is pulled backward, the controller sends a signal to close the engine throttle and reduce the lifting force of the rotors. This configuration advantageously allows complete one-handed control of the helicopter, allowing the user the make control changes while also handling equipment such as binoculars, a camera, etc.

It will be apparent that other control configurations may also be used. For example, a moveable yoke with a rotatable steering wheel similar to that used in airplanes could be used for pitch and roll control, with foot pedals attached to the forward boom for yaw control. Any combination of operator actuatable controls which will allow independent control of the flight functions of the aircraft may be used.

As noted above, the helicopter employs a fly-by-wire control system. While the operator manipulates the flight controls, these manipulations do not directly control the servo motors which actuate the helicopter's components. Instead, all control functions are governed by the electronic controller 250. The electronic controller receives signals from the motion sensors connected to the flight controls, and determines exactly what commands should be sent to the helicopter systems. This electronic control system allows the operator to effect desired movement of the helicopter, but continually keeps the craft stable regardless of the input, and does not allow the operator to perform certain actions which can be anticipated and prevented.

For example, control software in the controller may set a maximum descent rate. Accordingly, if the operator quickly lowers the throttle lever to a point which would otherwise cut all power to the engine if the throttle lever were directly connected thereto, the controller will not entirely close the throttle to stop the engine, but will slow the engine only enough to allow a reasonable maximum safe rate of descent. Similarly, if the operator were to attempt to roll the craft suddenly in a manner which ordinarily might cause it to become unstable, the controller would nevertheless send signals to the appropriate systems to roll and turn the helicopter approximately as directed, without allowing a loss of control. While no control system can anticipate all possible dangerous maneuvers, and operators still must watch for and avoid hazards, this system makes control of a relatively difficult type of aircraft simple for those without extensive training.

The computerized control of the helicopter is also advantageous in allowing automated flight control and hands-free operation. The electronic controller is preferably programmed to set control conditions based upon operator manipulation of the control devices, then hold those conditions. Accordingly, when the helicopter is brought to any relatively “steady-state” condition, the operator may release the controls and the craft will continue as the controls were set. For example, if the helicopter is flying straight and level, at a given speed, the operator may release the controls, and the craft will continue in that mode. Likewise, when hovering, the operator may release the controls and the helicopter will continue to hover automatically. To facilitate these features, an auto-hover button 280 and/or a control maintain button 282 may be disposed on the control panel 36. By pushing these buttons, the operator may ensure continued stable operation of the helicopter, even if the controls are inadvertently bumped or displaced.

These automatic control features may be very valuable for a wide variety of users, including search and rescue teams, hunters, photographers, scientists, and others. A searcher can fly relatively slowly, relatively close to the ground, looking for a lost child, etc., then take out a radio, cell phone, GPS transceiver, or other equipment to report or mark their location once they reach a given spot, without having to land. A hunter may quickly and easily search for game from the air, then when located, retrieve his rifle and fire from the air. A photographer or researcher may similarly reach a remote location, then use their equipment without danger to the stability of the aircraft.

To control the forward or backward motion of the helicopter, the operator tilts the control stick 38 forward or backward (relative to the axis of the airframe), this motion being detected by the pitch sensor 266. The signal produced by the pitch detector is transmitted to the electronic controller :250, where it is converted into signals for actuating one or both of the rotor control actuators to cause the rotor set to tilt forward or backward. To control roll of the helicopter, the operator tilts the control stick to the right or left, this motion being detected by the roll sensor 268, which sends a signal to the electronic controller. The electronic controller converts the roll signal into signals for actuating one or both of the rotor control actuators to cause the rotor set to tilt to the right or left side.

To control yaw of the helicopter, the operator rotates the handlebar to the right or left, or twists joystick to the right or left, this motion being detected by the yaw sensor 270. A signal indicative of the rotation of the handlebar travels to the electronic controller 250, which in turn sends signals to the yaw paddle servo for causing the yaw paddles to rotate one direction or the other. The user can thus easily control lift by manipulating the throttle lever 40, or throttle control button 278, and controls the forward, backward, side to side, and rotational motion of the helicopter by means of the control stick. Adjustability of control sensitivity is also provided.

The simplified electronic control system described controls all functions of the helicopter in response to pilot input. By not using heavy levers, cables, pulleys, etc., the electronic control system greatly reduces the weight of the helicopter. At the same time, the fly-by-wire system allows for advanced functions like auto-hover, cruise-control, etc., and can be programmed to help prevent certain operator errors, as discussed above.

A schematic diagram of the electronic control system for controlling the helicopter is provided in the appended descriptive materials.

As yet another control alternative, the helicopter could be provided with remote control components to allow an operator to control the helicopter 10 from a remote location. Such a system would include a receiver 290 and an antenna 292 connected to the electronic controller 250, allowing the operator to control the pitch, roll, yaw, and lift of the helicopter using a conventional remote control transmitter 294 with typical remote control aircraft controls. Transmitter and receiver units for this application are widely commercially available. This embodiment could be useful for military reconnaissance operations, aerial inspection of hazardous sites, and even transport of small cargo or other operations where it is not desired to have an operator in the operator's seat.

One of the developmental difficulties encountered by makers of coaxial helicopters is the problem of auto-rotation. In a conventional single rotor helicopter, if power to the rotor fails, a controlled descent may be made through auto-rotation. As the craft falls, air rushing past the rotors causes the rotors to rotate, thus essentially producing a lifting force from the downward motion of the craft. Auto-rotation requires a certain minimum altitude to be effective, and also requires skilled handling by the pilot to be successful, but is a proven method for emergency landings.

Unfortunately, coaxial helicopters are not capable of auto-rotation. Accordingly, some other provision must be made for the possibility of power failure to the coaxial rotors. The inventors have developed emergency power systems which provide temporary power to the rotors for landing in the event of sudden loss of engine power. FIG. 13 is a closeup view of one embodiment of the emergency power system, which comprises a vessel 300 of compressed gas, such as air, and a rotary turbine actuator 302. In the event of a sudden loss of power to the rotors, either by operator actuation or by automatic engagement by the electronic controller 250, a ball valve 304 opens, allowing pressurized gas to escape from the gas vessel through a conduit 306 to the rotary turbine. The output shaft 308 of the rotary turbine is connected to the driveshaft which allows the turbine to power the rotors as soon as the turbine speed matches the rotor speed.

The gas vessel 300 is sized to contain a quantity of gas sufficient to power the turbine 302 for approximately 10-15 seconds. The pressure of the gas is such that the output torque of the turbine equals approximately 70% of the of the engine torque, allowing a controlled descent from up to about 100 feet elevation. The helicopter of the present invention is intended to be flown at low altitudes, typically less than about 30 feet above the ground, and not more than 100 feet. The gas turbine emergency power system allows the helicopter to be safely landed in case of complete power failure when it is being operated within intended limits. Advantageously, the electronic control system does not depend upon the engine for power, and will be able to control the attitude of the rotors and yaw paddles during such an emergency descent, allowing the attitude of the craft to be controlled for an upright landing.

As an alternative to the compressed air emergency power system, the helicopter may use a chemical gas generation system 320 to provide high pressure gas for the turbine.

As yet another alternative emergency power system, the tips of the rotors may be provided with small rocket engines. It will be apparent that, because of greater leverage or mechanical advantage, the force required to rotate the rotors from the ends is relatively small compared to the torque required in the rotor shaft, and consequently, relatively small and unobtrusive rockets may be used. These rockets are preferably solid propellant rockets that are electrically actuable. Actuation is effected through wires 332 from the controller 250, and extending through the center of each rotor blade. The wires may be electrically connected through the transmission via a commutator 334. If power to the rotors fails, a signal is sent to all rockets 330 simultaneously, causing them to ignite and temporarily rotate the rotors. The rockets are configured to produce thrust for approximately 10-20 seconds at 70% of the normal helicopter thrust, thus allowing a controlled descent from a height less than 100 feet. It will be apparent that the rockets will require replacement after each use for the emergency power system to be operable.

It is well known that when the rotational force for a helicopter rotor comes from the rotors, rather than the rotor shaft, there is no opposing force which tends to rotate the airframe and needs to be resisted by a tail rotor or counter-rotating main rotor. Consequently, if a means for disengaging the bevel gear mechanism from either the top or bottom rotor were provided, emergency power rockets could be provided on only one of the two rotor sets, and still allow emergency landing. However, such a configuration is not preferred because of the added w eight and complexity that an additional clutch or similar mechanism would introduce.

As another safety mechanism, the pontoons 52 could be configured to function as emergency air bags In this embodiment, the pontoons are provided with emergency bloat valves 340, which automatically release when the air pressure in the pontoons spikes rapidly. For example, upon a vary hard landing, the pressure spike in the pontoons causes the blow valves to pop, allowing the air in the pontoons to rapidly escape, thus absorbing much of the impact.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements.

1. A rotorcraft comprising:
an airframe, further comprising:
a lightweight rigid frame member extending from a bottom portion of the airframe to a top portion of the airframe;
a forwardly extending boom depending from the lightweight rigid frame member;
a rearwardly extending boom depending from the lightweight rigid frame member;
a ballast configured to depend from at least one of: the forwardly extending boom; and, the rearwardly extending boom;
a prime mover carried by the lightweight rigid frame member;
a rotor having a rotational axis and a rotor thrust vector and connected to the airframe and operatively connected to the prime mover;
an operator seat carried by at least one of the lightweight rigid frame member and the forwardly extending boom and the rearwardly extending boom;
a control system further comprising a operator/control interface and a control/rotor interface, whereby the rotor thrust vector can be moved in relation to the airframe.

2. A rotorcraft as set forth in claim 1, wherein the rotor thrust vector is moved with respect to the airframe by tipping the rotational axis with respect to the airframe.

3. A rotorcraft as set forth in claim 2, further comprising a transmission tipably connected to the airframe, and tipable with the rotor.

4. A rotorcraft as set forth in claim 2, wherein the tipping of the rotor is actuatable by a plurality of cables.

5. A rotorcraft as set forth in claim 1, wherein the operator/control interface comprises a handlebar yoke, which is tipable with respect to the airframe, and is configured to control pitch and roll attitude by tipping with respect to a pitch axis and a roll axis.

6. A rotorcraft as set forth in claim 1, wherein the ballast comprises one of: a weight; and, tank configured to hold a pourable substance.

7. A rotorcraft as set forth in claim 6, wherein the prime mover comprises a 4-stroke internal combustion engine.

8. A rotorcraft as set forth in claim 1, wherein the lightweight rigid frame member is formed of a composite material.

9. A rotorcraft as set forth in claim 8, wherein the lightweight rigid frame member is configured so as to have a box section.

10. A rotorcraft as set forth in claim 8, wherein the lightweight rigid frame member includes panels of a first material connected by connection members formed of a second, different, material.

11. A rotorcraft as set forth in claim 10, wherein the first material is a fiber/resin composite material and the second material is an extruded aluminum material.

12. A rotorcraft as set forth in claim 1, further comprising a yaw paddle supported by one of said booms depending from the lightweight rigid frame member.

13. A rotorcraft as set forth in claim 1, further comprising a floatation device coupled to the airframe.

14. A rotorcraft as set forth in claim 13, further comprising a plurality of cross-members, and a plurality of pontoons, one of said cross members being attached to at least one of the lightweight rigid frame member and one of the at least one forwardly extending boom and the at least one rearwardly extending boom, and the cross-members being connected to the plurality of pontoons.

15. A rotorcraft as set forth in claim 1, further comprising a stability augmentation system.

16. A rotorcraft as set forth in claim 15, wherein the stability augmentation system is overridable by a pilot.

17. A rotorcraft as set forth in claim 16, further comprising a plurality of jacketed push-pull cables, the pilot actuating the cables at the operator/control interface and the stability augmentation system actuating a jacket of the cables.

18. A rotorcraft as set forth in claim 17, further comprising a plurality of links between the cables and the rotor, and wherein the control/rotor interface comprises moving the thrust vector with respect to the airframe by actuation of said links.

19. A rotorcraft as set forth in claim 1, wherein the rotor comprises a coaxial rotor set including a plurality of counter-rotating rotors rotating about a common rotor axis.

20. A rotorcraft as set forth in claim 19, further comprising a transmission disposed between the rotor and the airframe, and where the rotor axis is tipable with respect to the airframe by means of tipping the transmission with respect to the airframe.

21. A method of controlling a rotorcraft comprising (Jason has prior art, check it).

22. A rotorcraft comprising:
a box-section lightweight rigid frame member;
a forwardly extending boom depending from the box-section lightweight rigid frame member;
a rearwardly extending boom depending from the box section lightweight rigid frame member;
a yaw paddle carried by the rearwardly extending boom;
a prime mover carried by the box-section lightweight rigid frame member;
a rotor operatively connected to the prime mover, and tiltably connected to the lightweight rigid frame member,
a control system, further comprising a handlebar yoke operatively connected to the rotor and to the yaw paddle, and configured to tilt the rotor with respect to the airframe by tilting the handlebar yoke with respect to the airframe with respect to pitch and roll axes, and to actuate the yaw paddle by rotating the handlebar yoke with respect to the airframe with respect to a yaw axis
a pilot support carried by at least one of the lightweight box section frame member, forwardly extending boom and rearwardly extending boom, said support being proximate the handlebar yoke to facilitate control of the rotorcraft by a pilot.

23. A rotorcraft as set forth in claim 22, further comprising a cantilever support extending one of forwardly or rearwardly of the lightweight box section frame member enabling a tipable connection between the rotor and the lightweight box-section frame member to be located one of forward or aft of the lightweight box section frame member.

24. A rotorcraft as set forth in claim 23, wherein the rotorcraft is configured so that a pilot is positioned under a location of said tipable connection between the rotor and the lightweight box section frame member.

25. A rotorcraft as set forth in claim 24, further comprising a fuel tank positioned adjacent the pilot and under said location of said tipable connection.
